(19) United States
(12) Patent Application Publication
(10) Pub. No.: US 2016/0012676 A1
(43) Pub. Date: Jan. 14, 2016

(54) SYSTEMS AND METHODS FOR INTELLIGENT GAMING FILTERS

(71) Applicants: Rory Alexander Crabtree HOWARD, Jersey City, NJ (US); GAMESYS LTD, London (GB)

(72) Inventor: Rory Alexander Crabtree Howard, Jersey City, NJ (US)

(21) Appl. No.: 14/775,787

(22) PCT Filed: Mar. 13, 2014
(86) PCT No.: PCT/US2014/025651

§ 371 Date: Sep. 14, 2015

Related U.S. Application Data
(60) Provisional application No. 61/780,972, filed on Mar. 13, 2013.

(51) Int. Cl. G07F 17/32; H04L 29/08; H04L 29/06

(52) U.S. Cl. CPC G07F 17/3241; H04L 67/38; H04L 67/306; G07F 17/3211; G07F 17/323; G07F 17/3239

(57) ABSTRACT

Systems, methods, and articles of manufacture provide for intelligent gaming filters.

### CROSS-REFERENCE TO RELATED APPLICATIONS

This application is a National stage of and claims benefit and priority to International Application No. PCT/US14/25651 filed Mar. 13, 2014 on and titled “SYSTEMS AND METHODS FOR INTELLIGENT GAMING FILTERS”, which itself claims benefit and priority to U.S. Provisional Patent Application No. 61/780,972 filed on Mar. 13, 2013 and titled “SYSTEMS AND METHODS FOR INTELLIGENT GAME LOBBIES”, the entirety of each of which is hereby incorporated by reference herein.

### BACKGROUND

Players of online games, particularly wagering games, often search for game sessions that match various desired criteria. A player may search, for example, for a gaming session that has a particular type of gambling limit (e.g., a fixed-limit, pot-limit, or no-limit) or for a particular type of game or game session (e.g., Texas Hold'em, Omaha, stud, or draw poker). Some gambling jurisdiction may require players to establish a gambling loss limits within which they are expected to play (e.g., maximum loss of twenty dollars ($20) per day). Existing systems for gaming session searching and/or selection, however, fail to address or solve various problems.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a block diagram of a system according to some embodiments;

FIG. 3 is a flow diagram of a method according to some embodiments;

FIG. 4 is a block diagram of an apparatus according to some embodiments; and

FIG. 5A, FIG. 5B, FIG. 5C, FIG. 5D, and FIG. 5E are perspective diagrams of exemplary data storage devices according to some embodiments.

### DETAILED DESCRIPTION

### I. Introduction

Embodiments presented herein are descriptive of systems, apparatus, methods, and articles of manufacture for intelligent gaming filters. While existing applications allow a player to search for available game sessions utilizing various search terms, for example, such applications place the burden of selecting search terms and sifting through search results, on the player. This search process wastes the player's time, causing frustration and delay. In the case of wagering games (or other games associated with paid game play), such delay may equate to lost revenues for the gaming entity providing a particular game that the player desires to play.

### II. Systems

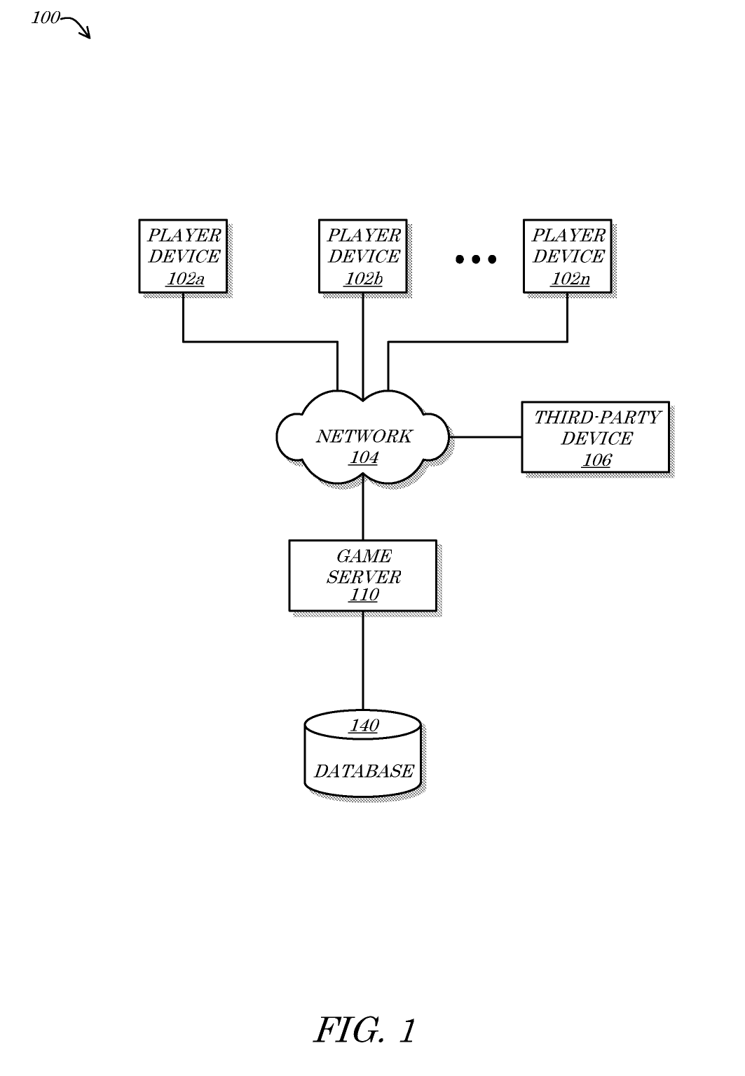

Turning first to FIG. 1, a block diagram of a system 100 according to some embodiments is shown. In some embodiments, the system 100 may comprise a gaming platform such as a gaming platform via which one or more multiplayer and/or online games may be played (e.g., one or more games initiated based on a filtered set of available gaming sessions, as described herein). In some embodiments, the system 100 may comprise a plurality of player devices 102a-n in communication with and/or via a network 104. In some embodiments, one or more of a third-party device 106 and a game server 110 may be in communication with the network 104 and/or one or more of the player devices 102a-n. In some embodiments, the game server 110 (and/or the player devices 102a-n and/or third-party device 106) may be in communication with a database 140. The database 140 may store, for example, game and/or gaming restriction data (e.g., processed and/or defined by the game server 110), data associated with players (not explicitly shown) owning and/or operating the player devices 102a-n, and/or instructions that cause various devices (e.g., the game server 110, the player devices 102a-n, and/or the third-party device 106) to operate in accordance with embodiments described herein.

According to some embodiments, any or all of the components 102a-n, 104, 106, 110, 140 of the system 100 may be similar in configuration and/or functionality to any similarly named and/or numbered components described herein. Fewer or more components 102a-n, 104, 106, 110, 140 (and/or portions thereof) and/or various configurations of the components 102a-n, 104, 110, 140 may be included in the system 100 without deviating from the scope of embodiments described herein. While multiple instances of some components 102a-n are depicted and while single instances of other components 104, 106, 110, 140 are depicted, for example, any component 102a-n, 104, 106, 110, 140 depicted in the system 100 may comprise a single device, a combination of devices and/or components 102a-n, 104, 106, 110, 140, and/or a plurality of devices, as is or becomes desirable and/or practicable. Similarly, in some embodiments, one or more of the various components 102a-n, 104, 106, 110, 140 may not be needed and/or desired in the system 100.

The player devices 102a-n, in some embodiments, may comprise any type or configuration of electronic, mobile electronic, and or other network and/or communication devices (or combinations thereof) that are or become known or practicable. A first player device 102a may, for example, comprise one or more PC devices, computer workstations (e.g., game consoles and/or gaming computers), tablet computers, such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, one or more of the player devices 102a-n may be specifically utilized and/or configured (e.g., via specially-programmed and/or stored instructions such as may define or comprise a software application) to communicate with the game server 110 and/or the third-party device 106 (e.g., via the network 104).

The network 104 may, according to some embodiments, comprise a LAN, WAN, cellular telephone network, Bluetooth® network, NFC network, and/or RF network with communication links between the player devices 102a-n, the third-party device 106, the game server 110, and/or the database 140. In some embodiments, the network 104 may comprise direct communications links between any or all of the other components 102a-n, 106, 110, 140 of the system 100. The game server 110 may, for example, be directly interfaced or connected to the database 140 via one or more wires, cables, wireless links, and/or other network components, such network components (e.g., communication links) comprising portions of the network 104. In some embodiments, the network 104 may comprise one or many other links or network components other than those depicted in FIG. 1. A second player device 102b may, for example, be connected to the game server 110 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the other components 102a-n, 106, 110, 140 of the system 100. The network 104 may comprise one or more cellular telephone networks with communication links between the player devices 102a-n, the third-party device 106, and the game server 110, for example, and/or may comprise the Internet (and/or a portion thereof), with communication links between the player devices 102a-n and the database 140, for example.

According to some embodiments, the game server 110 may comprise a device (and/or system) owned and/or operated by or on behalf of or for the benefit of a game provider (not explicitly shown). The game provider may utilize player and/or game information or instructions (e.g., stored by the database 140), in some embodiments, to host, manage, analyze, design, define, price, conduct, and/or otherwise provide (or cause to be provided) one or more games such as online multiplayer games (e.g., one or more games initiated based on a filtered set of available gaming sessions, as described herein). In some embodiments, the game provider (and/or a third-party; not explicitly shown) may provide an interface (not shown in FIG. 1) to and/or via the player devices 102a-n. The interface may be configured, according to some embodiments, to allow and/or facilitate electronic game play by one or more players and/or to specifically provide to such players filtered listings of available game sessions, such as based on player gaming restrictions, as described herein. In some embodiments, the system 100 (and/or interface provided by the game server 110) may present game data (e.g., from the database 140) in such a manner that allows players to participate in one or more online games (singularly, in/with groups, and/or otherwise). According to some embodiments, the game server 110 may cause and/or facilitate play of one or more games selected from a filtered game session listing, as described herein.

In some embodiments, the database 140 may comprise any type, configuration, and/or quantity of data storage devices that are or become known or practicable. The database 140 may, for example, comprise an array of optical and/or solid-state hard drives configured to store player and/or game data, and/or various operating instructions, drivers, etc. While the database 140 is depicted as a stand-alone component of the system 100 in FIG. 1, the database 140 may comprise multiple components. In some embodiments, a multi-component database 140 may be distributed across various devices and/or may comprise remotely dispersed components. Any or all of the player devices 102a-n may comprise the database 140 or a portion thereof, for example, and/or the game server 110 and/or third-party device 106 may comprise the database 140 or a portion thereof.

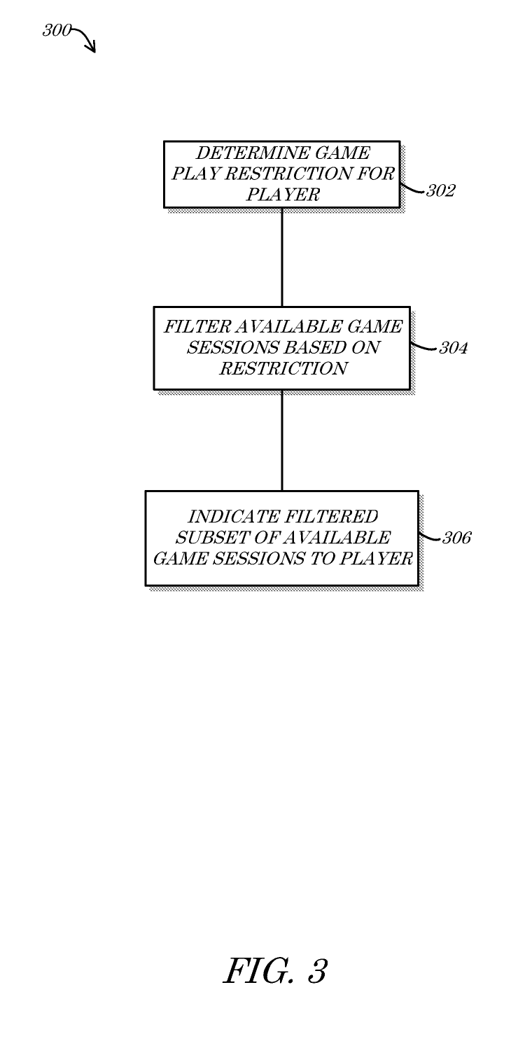

According to some embodiments, any or all of the player devices 102a-n in conjunction with one or more of the game server 110, the third-party device 106, and/or the database 140 (e.g., via the network 104) may conduct (in whole or in part), facilitate, and/or otherwise be associated with execution of one or more stored procedures, applications, processes, and/or methods (e.g., the method 300 of FIG. 3 herein, and/or one or more portions thereof) as described herein.

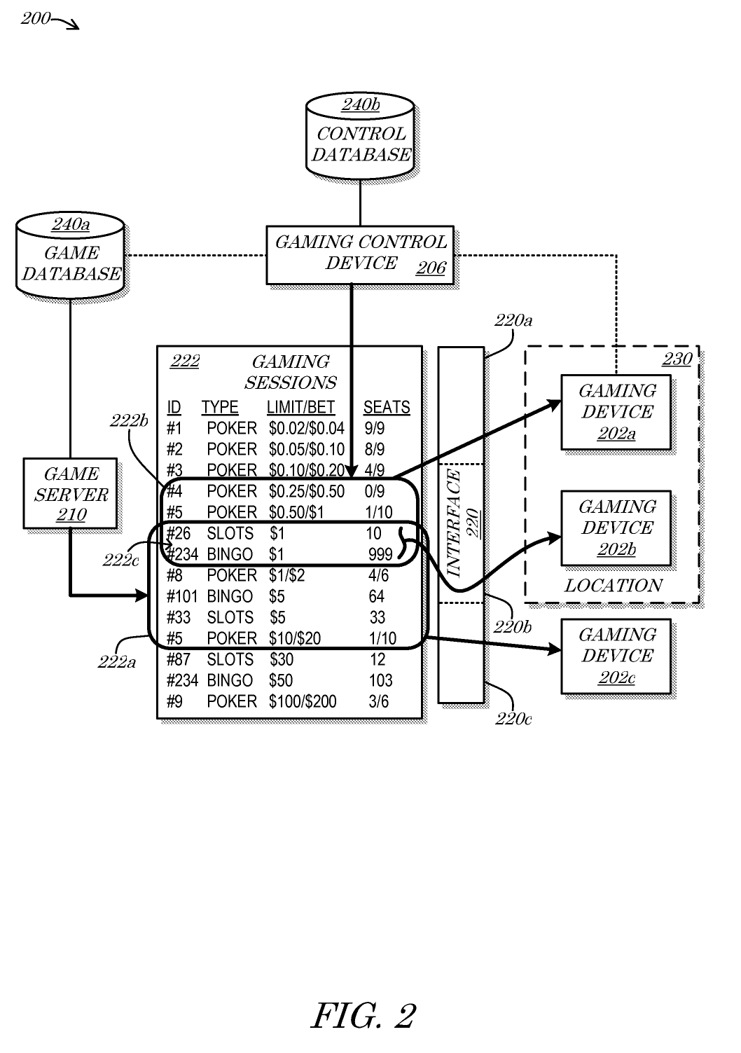

Referring now to FIG. 2, a block diagram of a system 200 according to some embodiments is shown. In some embodiments, the system 200 may comprise a gaming platform such as a platform via which social, multiplayer, and/or online games may be played. In some embodiments, the system 200 may comprise a plurality of gaming devices 202a-c, a gaming control device 206, and/or a game server 210. According to some embodiments, the game server 210 may generate and/or provide an interface 220 (e.g., comprising a plurality of sub-interfaces 220a-c) that may, for example, provide a listing 222 of available gaming sessions (e.g., for one or more types of games). In some embodiments, the listing 222 may comprise and/or be segmented, filtered, split, and/or categorized into a plurality of subsets 222a-c. According to some embodiments, one or more of the gaming devices 202a-c may reside and/or be located or otherwise associated with a particular location 230. In some embodiments, the system 200 may comprise one or more databases 240a-b (such as a game database 240a and/or a control database 240b) in communication with one or more of the gaming devices 202a-c, the gaming control device 206, and/or the game server 210.

According to some embodiments, any or all of the components 202a-c, 206, 210, 220a-c, 222a-c, 230, 240a-b of the system 200 may be similar in configuration and/or functionality to any similarly named and/or numbered components described herein. Fewer or more components 202a-c, 206, 210, 220a-c, 222a-c, 230, 240a-b (and/or portions thereof) and/or various configurations of the components 202a-c, 206, 210, 220a-c, 222a-c, 230, 240a-b may be included in the system 200 without deviating from the scope of embodiments described herein. While multiple instances of some components 202a-c, 220a-c, 222a-c, 240a-b are depicted and while single instances of other components 206, 210, 230 are depicted, for example, any component 202a-c, 206, 210, 220a-c, 222a-c, 230, 240a-b depicted in the system 200 may comprise a single device, a combination of devices and/or components 202a-c, 206, 210, 220a-c, 222a-c, 230, 240a-b, and/or a plurality of devices, as is or becomes desirable and/or practicable. Similarly, in some embodiments, one or more of the various components 202a-c, 206, 210, 220a-c, 222a-c, 230, 240a-b may not be needed and/or desired in the system 200.

According to some embodiments, the server 210 may be configured (i.e., specially-programed) to provide the listing 222 (and/or subsets 222a-c as described herein), via the interface 220 (and/or sub-interfaces 220a-c thereof), to one or more of the player devices 202a-c. In some embodiments, the game server 210 may provide the listing 222 which may then be filtered by the interface 220. The interface 220 and/or associated gaming devices 202a-c, for example, may filter the listing 222 provided by the server to create and/or define the subsets 222a-c, which are then output via the respective gaming devices 202a-c. In some embodiments, the gaming control device 206 and/or the game server 210 may filter or parse the listing 222 to create and/or define the subsets 222a-c. The game server 210 may, for example, access gaming restriction data from the game database 240a, gaming devices 202a-c, and/or gaming control device 206 (and/or control database 240b), which may be utilized to determine which game sessions indicated by the listing 222 should be provided to which gaming devices 202a-c. According to some embodiments, the gaming control device 206 (e.g., a device of a gaming control and/or regulatory entity or authority; not explicitly shown) may also or alternatively filter the listing 222 to create and/or define the subsets 222a-c.

In some embodiments, player gaming restriction data (e.g., stored by one or more of the databases 240a-b) may be utilized to filter the listing 222 to create and/or define the subsets 222a-c. The game server 210 may, in one example, utilize a third player's stored loss limit data (e.g., stored in the game database 240a, queried from the control database 240b and/or the gaming control device 206, and/or received from a third gaming device 202c) to determine that the third player should be limited to play in a first subset 222a of gaming sessions. It may be determined, for example, that certain gaming sessions such as session “#9” comprising a poker-style game with one hundred dollar ($100)/two hundred dollar ($200) stakes should not be provided to the third gaming device 202c (e.g., via a third sub-interface 222c), such as in the case that the third player has a daily loss limit (and/or deposit limit or spend limit) less than one hundred dollars ($100)—i.e., if the third player with such a loss limit were allowed to enter the session “#9”, the third player would either not be able to fully fund a round of betting in a single game play or would exceed the loss limit after a single loss event. In some embodiments, certain game sessions with lower cost options/parameters may also or alternatively be excluded from the first subset 222a. It may be determined, for example, that the third player's loss limit of one hundred dollars ($100) per day (to continue the non-limiting example) would likely permit the third player to play a large number (e.g., over a certain threshold such as two hundred (200)) of game rounds/spins/turns and/or play for a large amount of time (e.g., over a certain time threshold such as ten (10) or twenty-four (24) hours) if the third player were allowed to play in the session “#1” having stakes of two cents ($0.02)/four cents ($0.04). In some embodiments, only game sessions matching and/or satisfying player gaming restriction criteria may be included in the first subset 222a.

According to some embodiments, the gaming control device 206 may be utilized to filter or limit the listing 222 to a second subset 222b. The gaming control device 206 may, for example, utilize gaming restriction data stored in the control database 240b to determine that certain players and/or player devices 202a-c should be presented with the second subset 222b as opposed to the full listing 222 of available gaming sessions. In some embodiments, the gaming control device 206 (and/or the server 210) may define the second subset 222b based on the location 230. In such an embodiments, for example, both a first gaming device 202a and a second gaming device 202b (each being associated with—e.g., located in, the location 230) may be provided with identical or similar subsets 222a-c based on their shared location 230. In some embodiments, one or more of the gaming devices 202a-c may be provided with a subset 222a-c that comprises a portion (e.g., sub-subset) of another subset 222a-c. As depicted in FIG. 2, for example, while both the first gaming device 202a and the second gaming device 202b are limited to receiving the second subset 222b of the listing 222 (e.g., due to their shared location 230 and/or otherwise), the second gaming device 202b may be further limited. The second gaming device 202b may, in some embodiments for example, be limited to receiving a third subset 222c that comprises a sub-portion of the second subset 222b.

In some embodiments, the third subset 222c may comprise and/or be defined by an intersection and/or overlap of the first subset 222a and the second subset 222b. The third subset 222c may, for example, comprise a filtered version of the listing 222 that includes only those gaming sessions that are indicated as acceptable (e.g., qualifying and/or satisfying one or more criteria such as a gaming restriction criteria) by both the server 210 (e.g., a gaming provider) and the gaming control device 206 (e.g., a gaming regulatory entity). According to some embodiments, the filtering of the listing 222 may comprise removing any gaming session entries that do no satisfy a relevant criteria, thereby defining one of the subsets 222a-c. Such subsets 222a-c may then be provided to the gaming devices 202a-c (e.g., via the interface 220 and/or one of the sub-interfaces 222a-c thereof). In some embodiments, the entire listing 222 of available gaming sessions may be provided to the gaming device 202a-c, but one or more of the appropriate subsets 222a-c may be specifically indicated and/or set apart from filtered or non-qualifying gaming sessions. While the entire listing 222 may be provided to the second gaming device 202b, for example, any gaming sessions that are not members of the third subset 222c may be altered in appearance (e.g., “greyed out”, struck-through) and/or altered in visible content. While the gaming session “#3” has only four (4) of nine (9) available seats/positions filled, for example, as the gaming session “#3” is not a member of the third subset 222c, an indication of the gaming session “#3” to the second gaming device 202b (e.g., via the second sub-interface 220b) may instead indicate that the session is full (e.g., seats/positions=“9/9”; i.e., nine (9) our of nine (9) spaces filled/occupied). In such a manner, for example, a player may be discouraged and/or blocked from entering non-qualifying gaming sessions. In some embodiments, the number of seats/positions available may be defined by one or more variables and/or values that may be changed with respect to one or more players and/or player devices 202a-c (and/or locations 230)—e.g., effectively locking non-qualifying sessions with respect to certain players, player devices 202a-c, and/or play locations 230.

### III. Methods

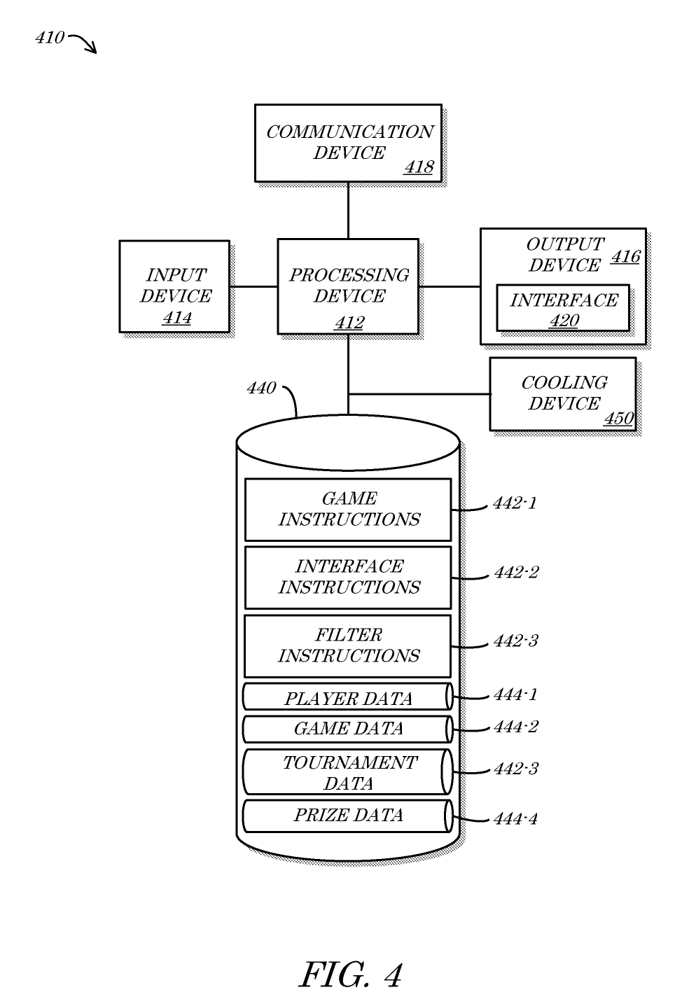

Referring now to FIG. 3, a flow diagram of a method 300 according to some embodiments is shown. In some embodiments, the method 300 may be performed and/or implemented by and/or otherwise associated with one or more specialized and/or computerized processing devices (e.g., the player and/or gaming devices 102a-n, 202a-c, the third-party device and/or gaming control device 106, 206, and/or the servers or apparatus 110, 210, 410 of FIG. 1, FIG. 2, and/or FIG. 4 herein), specialized computers, computer terminals, computer servers, computer systems and/or networks, and/or any combinations thereof (e.g., by one or more online game providers and/or online gaming processing devices). In some embodiments, the method 300 may be embodied in, facilitated by, and/or otherwise associated with various input mechanisms and/or interfaces (e.g., the interfaces 220, 420 of FIG. 2 and/or FIG. 4 herein).

The process and/or flow diagrams described herein do not necessarily imply a fixed order to any depicted actions, steps, and/or procedures, and embodiments may generally be performed in any order that is practicable unless otherwise and specifically noted. Any of the processes and/or methods described herein may be performed and/or facilitated by hardware, software (including microcode), firmware, or any combination thereof. For example, a storage medium (e.g., a hard disk, Universal Serial Bus (USB) mass storage device, and/or Digital Video Disk (DVD)) may store thereon instructions that when executed by a machine (such as a computerized processing device) result in performance according to any one or more of the embodiments described herein.

In some embodiments, the method 300 may comprise determining (e.g., by a processing device) a game play restriction for a player, at 302. One or more variables, metrics, rules, criteria, values, and/or data descriptive of a gaming restriction applicable to one or more players may, for example, be received from a player and/or third-party (and/or one or more devices owned and/or operated by such players and/or third-parties). According to some embodiments, player login credentials (e.g., an indicator of a player identifier and/or a password, key, or code) may be received from a player device, such as upon a player logging into a gaming website (e.g., an online gambling website). Such credentials may be utilized, for example, to identify a player account associated with the player and/or to identify one or more stored values and/or data items associated therewith (e.g., a gaming restriction for the player). In some embodiments, the player's login credentials may be verified, such as by confirming that the credentials are properly associated with a pre-existing player account.

According to some embodiments, the identity of the player and/or player account may be utilized to retrieve data defining and/or descriptive of a player gaming restriction. Information identifying the player may, for example, be provided to a gaming control and/or regulatory entity (e.g., a third-party) as an information request and such entity may provide (e.g., in response to the request) an indication and/or definition of the player's gaming restriction(s). In some embodiments, information descriptive of the player (e.g., a player identifier) may be utilized to query a database of a third-party such as a gaming control entity to determine data descriptive of the gaming restriction. According to some embodiments, information descriptive of and/or defining the gaming restriction(s) may be received from a player device. The player may, for example, specify a type and/or value/extent of the restriction and/or any timing considerations or variables associated therewith. This is different from a mere receipt or identification of search terms in several respects.

Gaming restrictions, for example, may include timing variables and/or limitations such as, e.g., a player's maximum wager amount per time period (e.g., the player cannot wager more than ten dollars ($10) per fifteen (15) minutes), a maximum loss limit per time period (e.g., the player cannot lose more than twenty dollars ($20) per day), and/or a restriction time window (e.g., loss limits or wager limits are active during business hours). Game sessions meeting such time-based restriction criteria/requirements may be determined in various ways.

Gaming restrictions may also or alternatively comprise other variables and/or rules that cannot directly be equated to game session characteristics. While a game session may have a buy-in of five dollars ($5), for example, a game restriction may comprise a rule that a player cannot wager more than one hundred dollars ($100) per hour. In such cases, the method 300 may comprise determining a relationship between the gaming restriction and one or more game session characteristics. It may be determined, for example, that the average (maximum, median, and/or other mathematical and/or statistical variable) amount wagered per hour in game sessions having buy-ins greater than five dollars ($5) is one hundred and ten dollars ($110). According to some embodiments, such a relationship may dictate that only game sessions with buy-ins of five dollars ($5) or less meet the wager per hours gaming restriction for the player. In some embodiments, such as in the case that the gaming restriction comprises a loss limit, gaming data may be analyzed to determine which game types (e.g., which combinations of game session parameters) are conducive to game play in accordance with the restriction. In the case of a player's loss limit of ten dollar ($10) per hour, for example, historic gaming data may be analyzed (with respect to the player, players having similar attributes to the player, or all players) to determine a maximum permissible value for one or more game session parameters such as a maximum wager size, maximum limit size or stakes, and/or maximum buy-in. It may be determined, for example, that poker games with stakes greater than one dollar ($1)/two dollars ($2) are associated with losses in excess of ten dollar ($10) per hour more than half the time (e.g., fifty-five percent (55%) of the time). In the case that a qualification threshold is set to no more than fifty percent (50%), it may be determined that poker game sessions having stakes greater than one dollar ($1)/two dollars ($2) do not qualify for or satisfy the gaming restriction for the player. In some embodiments, other thresholds and/or relationships may be utilized as is or becomes desirable or practicable. In such a manner, for example, game sessions may be filtered based on variables that are not inherent to the game session attribute set—e.g., in previous systems, players can search for game sessions having certain types of limits such as fixed-limit games sessions (in which case pot-limit or no-limit games would not be returned in a listing of search results), but such players cannot search for game sessions that have stakes that are compatible with a maximum daily loss limit of a particular magnitude.

According to embodiments, the method 300 may comprise filtering (e.g., by the processing device) available game sessions, at 304. A listing of available (e.g., current, active, and/or open) game sessions may, for example, be queried, uploaded, retrieved, calculated, searched, and/or otherwise determined. In some embodiments, a plurality of available game sessions may be analyzed to determine which sessions satisfy the gaming restriction criteria (e.g., determined at 302). Game play data associated with particular games, game types, and/or session types (e.g., sessions having similar variable values) may, for example, be analyzed with respect to player data to determine relationships, statistics, and/or thresholds defining qualifying criteria. In some embodiments, the listing of available game sessions may be filtered such as by removing game sessions that do not meet gaming restriction criteria. According to some embodiments, qualifying and non-qualifying game sessions may be flagged or tagged to indicate compliance with the gaming restriction(s).

In some embodiments, the method 300 may comprise indicating (e.g., by the processing device and/or via an electronic communications network device) the filtered subset of available game sessions to the player, at 306. In the case that the listing of available sessions has been filtered, for example, the filtered game session listing may be provided to a player via a game session selection interface. According to some embodiments, non-qualifying game sessions may be indicated to the player(s), but such sessions may be flagged, tagged, and/or highlighted to indicate their non-qualifying status. Non-qualifying game sessions may be grayed out, for example, presented in a smaller font, and/or may have any hyperlink and/or interactive capabilities thereof disabled. According to some embodiments, game session characteristic data may be altered (or may appear to be altered) to discourage a player from selecting a game session that fails to satisfy the gaming restriction. In the case that a non-qualifying game session has several seats/player positions that are available (e.g., currently remain open), for example, an interface outputting a listing of game sessions to the player may instead show that the game session is full. In some embodiments, the capacity of the game session may indeed be altered with respect to certain players (such as payer shaving a gaming restriction that is determined to be incompatible with the game session).

According to some embodiments, the method 300 may comprise receiving (e.g. by the processing device) an indication of a player selection of one of the gaming sessions from the subset of available gaming sessions that satisfy the player gaming restriction, entering (e.g., by the processing device) the player into the player-selected gaming session, and/or facilitating (e.g., by the processing device) game play, by the player, in the player-selected gaming session. The method 300 may, for example, enable a player to select an appropriate game session from a filtered list of available game sessions (e.g., filtered based on a player' gaming restriction(s)) and enable the player to participate in a selected game session.

In some embodiments, a gaming incentive threshold may be determined. While the gaming restrictions may be utilized to filter and/or restrict or limit access to game sessions, for example, game sessions within the subset of qualifying sessions may be differently treated. It may be desirable, for example, to provide an incentive to players joining game sessions that meet standards higher (e.g., more stringent) than mere qualification based on gaming restrictions. In the case that a maximum wager, buy-in, limit and/or other variable is determined as a gaming restriction qualifying criteria, for example, a lower wager amount, buy-in, limit, and/or other variable may be determined and/or defined as a gaming incentive threshold. In the case that a gaming restriction comprises a loss limit of one hundred dollars ($100) per day and an associated game session criteria, threshold, or restriction is determined to comprise a maximum wager amount (e.g., a “max bet”) of one dollar ($1), for example, a gaming incentive threshold may be set at fifty percent (50%) of the maximum wager amount, or fifty cents ($0.50). In such an example case, incentives may be provided to the player for selecting and/or playing in a game session that satisfies the gaming incentive threshold. The player may be awarded, for example, free spins, free hands, discounts, free credits or chips, free game play time (e.g., a free month of play for subscription-model pay-to-play gaming, and/or in-game upgrades, free freemium features, etc.

### IV. Apparatus and Article of Manufacture

Turning to FIG. 4, a block diagram of an apparatus 410 according to some embodiments is shown. In some embodiments, the apparatus 410 may be similar in configuration and/or functionality to any of player and/or gaming devices 102a-n, 202a-c, the third-party and/or gaming control devices 106, 206, and/or the servers or apparatus 110, 210 of FIG. 1 and/or FIG. 2 herein, and/or may otherwise comprise a portion of the systems 100, 200 of FIG. 1 and/or FIG. 2 herein. The apparatus 410 may, for example, execute, process, facilitate, and/or otherwise be associated with the method 300 of FIG. 3 herein, and/or one or more portions thereof. In some embodiments, the apparatus 410 may comprise a processing device 412, an input device 414, an output device 416, a communication device 418, an interface 420, a memory device 440 (storing various programs and/or instructions 442 and data 444), and/or a cooling device 450. According to some embodiments, any or all of the components 412, 414, 416, 418, 420, 440, 442, 444, 450 of the apparatus 410 may be similar in configuration and/or functionality to any similarly named and/or numbered components described herein. Fewer or more components 412, 414, 416, 418, 420, 440, 442, 444, 450 and/or various configurations of the components 412, 414, 416, 418, 420, 440, 442, 444, 450 be included in the apparatus 410 without deviating from the scope of embodiments described herein.

According to some embodiments, the processing device 412 may be or include any type, quantity, and/or configuration of electronic and/or computerized processor that is or becomes known. The processing device 412 may comprise, for example, an Intel® IXP 2800 network processor or an Intel® XEON™ Processor coupled with an Intel® E7501 chipset. In some embodiments, the processing device 412 may comprise multiple inter-connected processors, microprocessors, and/or micro-engines. According to some embodiments, the processing device 412 (and/or the apparatus 410 and/or portions thereof) may be supplied power via a power supply (not shown) such as a battery, an Alternating Current (AC) source, a Direct Current (DC) source, an AC/DC adapter, solar cells, and/or an inertial generator. In the case that the apparatus 410 comprises a server such as a blade server, necessary power may be supplied via a standard AC outlet, power strip, surge protector, a PDU, and/or Uninterruptible Power Supply (UPS) device.

In some embodiments, the input device 414 and/or the output device 416 are communicatively coupled to the processing device 412 (e.g., via wired and/or wireless connections and/or pathways) and they may generally comprise any types or configurations of input and output components and/or devices that are or become known, respectively. The input device 414 may comprise, for example, a keyboard that allows an operator of the apparatus 410 to interface with the apparatus 410 (e.g., by a player, such as to participate in a game offered as part of a filtered game session listing, as described herein). In some embodiments, the input device 414 may comprise a sensor configured to provide information such as player input to the apparatus 410 and/or the processing device 412. The output device 416 may, according to some embodiments, comprise a display screen and/or other practicable output component and/or device. The output device 416 may, for example, provide the interface 420 to an end-user (e.g., via a website and/or electronic communications network device). According to some embodiments, the input device 414 and/or the output device 416 may comprise and/or be embodied in a single device such as a touch-screen monitor (e.g., a device capable of both receiving input and providing output).

In some embodiments, the communication device 418 may comprise any type or configuration of communication device that is or becomes known or practicable. The communication device 418 may, for example, comprise a network interface card (NIC), a telephonic device, a cellular network device, a router, a hub, a modem, and/or a communications port or cable. In some embodiments, the communication device 418 may be coupled to provide data to a user device (not shown in FIG. 4), such as in the case that the apparatus 410 is utilized to provide the interface 420 to a player and/or end-user as described herein. The communication device 418 may, for example, comprise a cellular telephone network transmission device that sends signals indicative of game interface components to customer and/or subscriber handheld, mobile, and/or telephone device. According to some embodiments, the communication device 418 may also or alternatively be coupled to the processing device 412. In some embodiments, the communication device 418 may comprise an IR, RF, Bluetooth™, NFC, and/or Wi-Fi® network device coupled to facilitate communications between the processing device 412 and another device (such as a player device and/or a third-party device).

The memory device 440 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 440 may, according to some embodiments, store one or more of game instructions 442-1, interface instructions 442-2, and/or filter instructions 442-3. In some embodiments, the game instructions 442-1, interface instructions 442-2, and/or filter instructions 442-3 may be utilized by the processing device 412 to provide output information via the output device 416 and/or the communication device 418.

According to some embodiments, the game instructions 442-1 may be operable to cause the processing device 412 to process player data 444-1, game data 444-2, tournament data 444-3, and/or prize data 444-4. Player data 444-1, game data 444-2, tournament data 444-3, and/or prize data 444-4 received via the input device 414 and/or the communication device 418 may, for example, be analyzed, sorted, filtered, decoded, decompressed, ranked, scored, plotted, and/or otherwise processed by the processing device 412 in accordance with the game instructions 442-1. In some embodiments, player data 444-1, game data 444-2, tournament data 444-3, and/or prize data 444-4 may be fed by the processing device 412 through one or more mathematical and/or statistical formulas and/or models in accordance with the game instructions 442-1 to provide one or more online games (e.g., games selected from filtered game session listings) in accordance with embodiments described herein.

In some embodiments, the interface instructions 442-2 may be operable to cause the processing device 412 to process player data 444-1, game data 444-2, tournament data 444-3, and/or prize data 444-4. Player data 444-1, game data 444-2, tournament data 444-3, and/or prize data 444-4 received via the input device 414 and/or the communication device 418 may, for example, be analyzed, sorted, filtered, decoded, decompressed, ranked, scored, plotted, and/or otherwise processed by the processing device 412 in accordance with the interface instructions 442-2. In some embodiments, player data 444-1, game data 444-2, tournament data 444-3, and/or prize data 444-4 may be fed by the processing device 412 through one or more mathematical and/or statistical formulas and/or models in accordance with the interface instructions 442-2 to provide one or more online gaming interfaces (e.g., filtered and/or defined based on gaming restrictions) in accordance with embodiments described herein.

According to some embodiments, the filter instructions 442-3 may be operable to cause the processing device 412 to process player data 444-1, game data 444-2, tournament data 444-3, and/or prize data 444-4. Player data 444-1, game data 444-2, tournament data 444-3, and/or prize data 444-4 received via the input device 414 and/or the communication device 418 may, for example, be analyzed, sorted, filtered, decoded, decompressed, ranked, scored, plotted, and/or otherwise processed by the processing device 412 in accordance with the filter instructions 442-3. In some embodiments, player data 444-1, game data 444-2, tournament data 444-3, and/or prize data 444-4 may be fed by the processing device 412 through one or more mathematical and/or statistical formulas and/or models in accordance with the filter instructions 442-3 to filter, define, and/or alter game session listings and/or interfaces in accordance with embodiments described herein

Any or all of the exemplary instructions and data types described herein and other practicable types of data may be stored in any number, type, and/or configuration of memory devices that is or becomes known. The memory device 440 may, for example, comprise one or more data tables or files, databases, table spaces, registers, and/or other storage structures. In some embodiments, multiple databases and/or storage structures (and/or multiple memory devices 440) may be utilized to store information associated with the apparatus 410. According to some embodiments, the memory device 440 may be incorporated into and/or otherwise coupled to the apparatus 410 (e.g., as shown) or may simply be accessible to the apparatus 410 (e.g., externally located and/or situated).

In some embodiments, the apparatus 410 may comprise the cooling device 450. According to some embodiments, the cooling device 450 may be coupled (physically, thermally, and/or electrically) to the processing device 412 and/or to the memory device 440. The cooling device 450 may, for example, comprise a fan, heat sink, heat pipe, radiator, cold plate, and/or other cooling component or device or combinations thereof, configured to remove heat from portions or components of the apparatus 410.

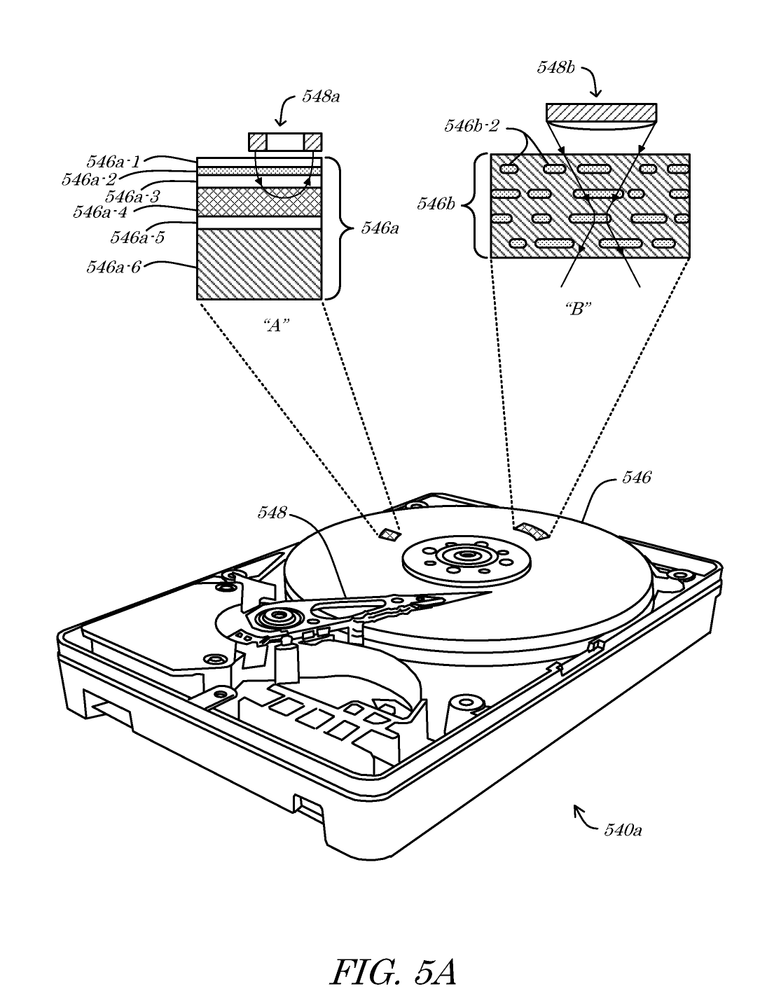

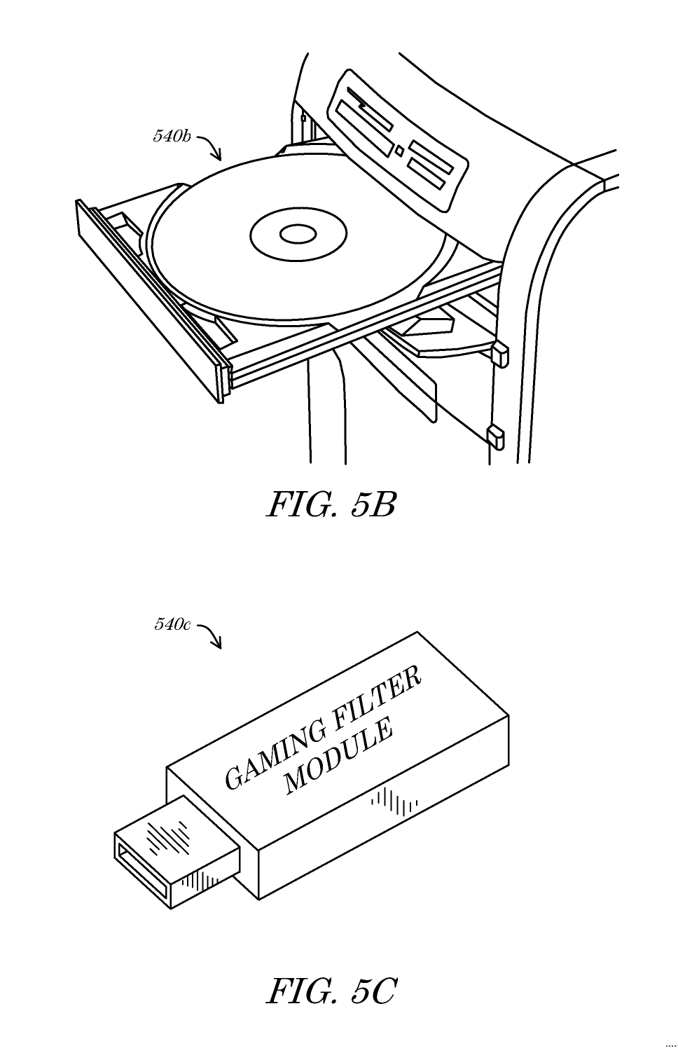

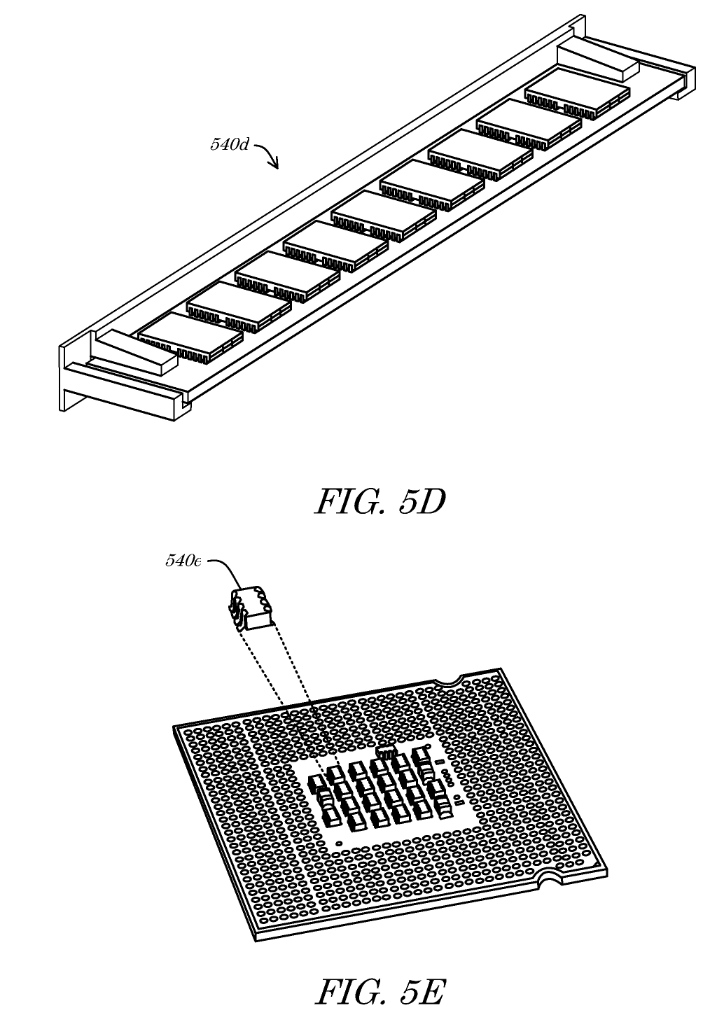

Referring now to FIG. 5A, FIG. 5B, FIG. 5C, FIG. 5D, and FIG. 5E, perspective diagrams of exemplary data storage devices 540a-e according to some embodiments are shown. The data storage devices 540a-e may, for example, be utilized to store instructions and/or data such as the game instructions 442-1, interface instructions 442-2, filter instructions 442-3, player data 444-1, game data 444-2, tournament data 444-3, and/or prize data 444-4, each of which is described in reference to FIG. 4 herein. In some embodiments, instructions stored on the data storage devices 540a-e may, when executed by a processor, cause the implementation of and/or facilitate the method 300 of FIG. 3 and/or portions thereof described herein.

According to some embodiments, the first data storage device 540a may comprise one or more various types of internal and/or external hard drives. The first data storage device 540a may, for example, comprise a data storage medium 546 that is read, interrogated, and/or otherwise communicatively coupled to and/or via a disk reading device 548. In some embodiments, the first data storage device 540a and/or the data storage medium 546 may be configured to store information utilizing one or more magnetic, inductive, and/or optical means (e.g., magnetic, inductive, and/or optical-encoding). The data storage medium 546, depicted as a first data storage medium 546a for example (e.g., breakout cross-section “A”), may comprise one or more of a polymer layer 546a-1, a magnetic data storage layer 546a-2, a non-magnetic layer 546a-3, a magnetic base layer 546a-4, a contact layer 546a-5, and/or a substrate layer 546a-6. According to some embodiments, a magnetic read head 546a may be coupled and/or disposed to read data from the magnetic data storage layer 546a-2.

In some embodiments, the data storage medium 546, depicted as a second data storage medium 546b for example (e.g., breakout cross-section “B”), may comprise a plurality of data points 546b-2 disposed with the second data storage medium 546b. The data points 546b-2 may, in some embodiments, be read and/or otherwise interfaced with via a laser-enabled read head 548b disposed and/or coupled to direct a laser beam through the second data storage medium 546b.

In some embodiments, the second data storage device 540b may comprise a CD, CD-ROM, DVD, Blu-Ray™ Disc, and/or other type of optically-encoded disk and/or other storage medium that is or becomes known or practicable. In some embodiments, the third data storage device 540c may comprise a USB keyfob, dongle, and/or other type of flash memory data storage device that is or becomes know or practicable. In some embodiments, the fourth data storage device 540d may comprise RAM of any type, quantity, and/or configuration that is or becomes practicable and/or desirable. In some embodiments, the fourth data storage device 540d may comprise an off-chip cache such as a Level 2 (L2) cache memory device. According to some embodiments, the fifth data storage device 540e may comprise an on-chip memory device such as a Level 1 (L1) cache memory device.

The data storage devices 540a-e may generally store program instructions, code, and/or modules that, when executed by a processing device cause a particular machine to function in accordance with one or more embodiments described herein. The data storage devices 540a-e depicted in FIG. 5A, FIG. 5B, FIG. 5C, FIG. 5D, and FIG. 5E are representative of a class and/or subset of computer-readable media that are defined herein as “computer-readable memory” (e.g., non-transitory memory devices as opposed to transmission devices or media).

The terms “computer-readable medium” and “computer-readable memory” refer to any medium that participates in providing data (e.g., instructions) that may be read by a computer and/or a processor. Such a medium may take many forms, including but not limited to non-volatile media, volatile media, and other specific types of transmission media. Non-volatile media include, for example, optical or magnetic disks and other persistent memory. Volatile media include DRAM, which typically constitutes the main memory. Other types of transmission media include coaxial cables, copper wire, and fiber optics, including the wires that comprise a system bus coupled to the processor.

Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable medium” and/or “tangible media” specifically exclude signals, waves, and wave forms or other intangible or transitory media that may nevertheless be readable by a computer.

Various forms of computer-readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined above and includes many exemplary protocols that are also applicable here.

In some embodiments, one or more specialized machines such as a computerized processing device, a server, a remote terminal, and/or a customer or user device may implement the various practices described herein. A computer system of an game provider may, for example, comprise various specialized computers that interact to provide for games conducted in accordance with filtered game session listings (e.g., customized game “lobbies”), as described herein.

### V. Terms and Definitions

Throughout the description that follows and unless otherwise specified, the following terms may include and/or encompass the example meanings provided in this section. These terms and illustrative example meanings are provided to clarify the language selected to describe embodiments both in the specification and in the appended claims, and accordingly, are not intended to be limiting. While not generally limiting and while not limiting for all described embodiments, in some embodiments, the terms are specifically limited to the example definitions and/or examples provided. Other terms are defined generally throughout the present description.

A “game”, as the term is utilized herein (unless otherwise specified), may generally comprise any game (e.g., wagering or non-wagering, skill-based, chance-based, playable by hand (e.g., utilizing non-electric physical components, boards, and/or pieces), and/or electronically playable over a network) playable by one or more players in accordance with specified rules. An electronic game may be playable on a Personal Computer (PC), online in web browsers, on a game console, and/or on a mobile device such as a smart-phone or tablet computer. “Gaming” thus generally refers to play of a game (e.g., by one or more players).

A “wager-style game”, as the term is utilized herein (unless otherwise specified), generally refers to a game that is played in the same manner as a wagering game, but does not technically qualify as gambling. Casual and/or social network games may, for example, be conducted in the same manner of game play as a wagering game such as slots, but may not accept true wagers from players and/or may otherwise differ from true wagering games.

A “casual game”, as the term is utilized herein (unless otherwise specified), may generally comprise a game with simple rules with little or no time commitment on the time of a player to play. A casual game may feature, for example, very simple game play such as a puzzle or Scrabble™ game, may allow for short bursts of play (e.g., during work breaks), an ability to quickly reach a final stage and/or continuous play without a need to save the game.

A “social network game”, as utilized herein (unless otherwise specified), generally refers to a type of online game that is played through a social network, and in some embodiments may feature multiplayer and/or asynchronous game play mechanics. A “social network” may refer to an online service, online community, platform, and/or site that focuses on facilitating the building of social networks or social relations among people. A social network service may, for example, consist of a representation of each user (often a profile), his/her social links, and a variety of additional services. A social network may be web-based and provide means for users to interact over the Internet, such as e-mail and instant messaging. A social network game may in some embodiments be implemented as a web browser and/or web-client game, a Flash®, or Java®-scripted game, and/or may be implemented on one or more mobile platforms such as on portable electronic devices.

A “wagering game”, as the term is utilized herein (unless otherwise specified), may generally comprise a game in which a player can risk a wager or other consideration, such as, but not limited to: slot-style games, poker games, blackjack, baccarat, craps, roulette, lottery, bingo, keno, casino war, etc. A wager may comprise a monetary wager in the form of an amount of currency or any other tangible or intangible article having some value which may be risked on an outcome of a wagering game. “Gambling” or “wagering” generally refers to play of a wagering game.

The term “game provider”, as utilized herein (unless otherwise specified), generally refers to an entity or system of components which provides games for play and facilitates play of such game by use of a network such as the Internet or a proprietary or closed networks (e.g., an intranet or local or wide area network). For example, a game provider may operate a website which provides games in a digital format over the Internet. In some embodiments in which a game comprising a wagering game is provided, a game provider may operate a gambling website over which wagers are accepted and results (e.g., winnings) of wagering games are provided.

As utilized herein, the term “player” may generally refer to any type, quantity, and or manner of entity associated with the play of a game. In some embodiments, a player may comprise an entity conducting play of an online game, for example, may comprise an entity that desires to play a game (e.g., an entity registered and/or scheduled to play and/or an entity having expressed interest in the play of the game—e.g., a spectator) and/or may comprise an entity that configures, manages, and/or conducts a game. A player may be currently playing a game or have previously played the game, or may not yet have initiated play—i.e., a “player” may comprise a “potential player” (e.g., in general and/or with respect to a specific game). In some embodiments, a player may comprise a user of an interface (e.g., whether or not such a player participates in a game or seeks to participate in the game). In some embodiments, a player may comprise an individual (or group) that enters, joins, logs into, registers for, and/or otherwise access an online game room, session, server, and/or other particular instance and/or segmentation of an online game.

Some embodiments described herein are associated with a “user device”, “player device”, “developer device”, or a “network device”. As utilized herein, “player devices”, “user devices”, and “developer devices” are one or more subsets of a “network device”. The “network device”, for example, may generally refer to any device that can communicate via a network, while the “player device” may comprise a network device that is owned and/or operated by or otherwise associated with a player (e.g., a network device specifically configured to permit use thereof by the player, such as by receiving login credentials from the player). Examples of player, user, developer, and/or network devices may include, but are not limited to: a PC, a computer workstation, a computer server, a printer, a scanner, a facsimile machine, a copier, a Personal Digital Assistant (PDA), a storage device (e.g., a disk drive), a hub, a router, a switch, and a modem, a video game console, or a wireless or cellular telephone. Player and/or network devices may, in some embodiments, comprise one or more network components. In some embodiments, a player device may comprise an electronic device configured to initiate, conduct, facilitate, and/or otherwise permit player participation in an electronic game.

As utilized herein, the term “network component” may refer to a player or network device, or a component, piece, portion, or combination of player or network devices. Examples of network components may include a Static Random Access Memory (SRAM) device or module, a network processor, and a network communication path, connection, port, or cable.

In addition, some embodiments are associated with a “network” or a “communication network.” As utilized herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration or type that is or becomes known. Communication networks may include, for example, devices that communicate directly or indirectly, via a wired or wireless medium such as the Internet, intranet, a Local Area Network (LAN), a Wide Area Network (WAN), a cellular telephone network, a Bluetooth® network, a Near-Field Communication (NFC) network, a Radio Frequency (RF) network, a Virtual Private Network (VPN), Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), and/or system to system (S2S).

As utilized herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard. Information may, according to some embodiments, be compressed, encoded, encrypted, and/or otherwise packaged or manipulated in accordance with any method that is or becomes known or practicable.

The term “indication”, as utilized herein (unless otherwise specified), may generally refer to any indicia and/or other information indicative of or associated with a subject, item, entity, and/or other object and/or idea. As utilized herein, the phrases “information indicative of and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

A “session”, as the term is utilized herein (unless otherwise specified), may generally comprise a period of time spanning a plurality of event instances (e.g., with respect to a communication and/or game session) or turns of a game, the session having a defined start and defined end. An event instance or turn is triggered upon an initiation of, or request for, at least one result of the game by a player, such as an actuation of a “start” or “spin” mechanism, which initiation causes an outcome to be determined or generated (e.g., an RNG is contacted or communicated with to identify, generate or determine a random number to be used to determine an outcome for the event instance).

As utilized herein, the terms “outcome” and “result” should be differentiated in the present description in that an “outcome” is generally a representation of a “result”, typically comprising one or more game elements or game symbols. For example, in a “fruit themed” slot-style game, a winning outcome (i.e., an outcome corresponding to some kind of award, prize or payout) may comprise a combination of three “cherry” symbols. The “result” of this outcome may be a payout of X credits awarded to the player associated with the game. In another example, in a game in which a character moves along a game interface from a starting position to a finish position, an “outcome” of the game may comprise a symbol representing one or more movements along the interface and the “result” corresponding to this outcome may be the particular number and direction of the character's movement (e.g., three (3) spaces backwards such that the character ends up further away from the finish line). In a session embodiment, a session result may comprise a binary result (e.g., a player or game character wins or loses the session) and/or the particular award (or magnitude of award) won or earned by the player based on the session (e.g., the number of credits awarded to the player). It should be noted that the embodiments described herein encompass awards, prizes and payouts which are monetary, non-monetary, tangible or intangible.

As utilized herein, the term “virtual currency” may generally refer to an in-game currency that may be utilized as part of a game or one or more games provided by a game provider as (i) currency for making wagers, and/or (ii) to purchase or access various in-game items, features or powers (e.g., “freemium” upgrades and/or options).

A “credit balance”, as the term is utilized herein (unless otherwise specified), may generally refer to (i) a balance of currency, whether virtual currency and/or real currency, usable for making wagers and/or purchases in a game and/or (ii) another tracking mechanism for tracking a player's success or advancement in a game by deducting there from points or value for unsuccessful attempts at advancement and adding thereto points or value for successful attempts at advancement.

Some embodiments are descriptive of an “array” or “matrix” of symbols or game outcomes. As utilized herein, the terms “array” and “matrix” generally refer to a group of symbols, numbers, and/or expressions arranged in a plurality of rows and columns (or that can be readily and appropriately represented mathematically as being so arranged). In some embodiments, the term “array” is utilized to refer to a multi-dimensional matrix or combination of matrices while the term “matrix” is utilized to refer to a two-dimensional set of symbols or numbers (e.g., slot reel symbols and/or mathematical representations thereof). According to some embodiments, such as in the case that an array and/or matrix is populated with graphical game symbols, the array or matrix may be output and/or displayed (e.g., transmit to and/or rendered on a player device) as part of a game session.

### VI. Rules of Interpretation

Numerous embodiments are described in this patent application, and are presented for illustrative purposes only. The described embodiments are not, and are not intended to be, limiting. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention that must be present in all embodiments. It is contemplated, however, that while some embodiment are not limited by the examples provided herein, some embodiments may be specifically bounded or limited by provided examples, structures, method steps, and/or sequences. Embodiments having scopes limited by provided examples may also specifically exclude features not explicitly described or contemplated.

Neither the Title (set forth at the beginning of the first page of this patent application) nor the Abstract (set forth at the end of this patent application) is to be taken as limiting in any way the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise. Similarly, any reference to an “alternate”, “alternative”, and/or “alternate embodiment” is intended to connote one or more possible variations—not mutual exclusivity. In other words, it is expressly contemplated that “alternatives” described herein may be utilized and/or implemented together, unless they inherently are incapable of being utilized together.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including the specification, its claims and figures, and anything which may be incorporated by reference, unless expressly specified otherwise.

The phrase “at least one of', when such phrase modifies a plurality of things (such as an enumerated list of things) means any combination of one or more of those things, unless expressly specified otherwise. For example, the phrase at least one of a widget, a car and a wheel means (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”. In some embodiments, a first thing being “based on” a second thing refers specifically to the first thing taking into account the second thing in an explicit manner. In such embodiments, for example, a processing step based on the local weather, which itself is in some manner based on or affected by (for example) human activity in the rainforests, is not “based on” such human activities because it is not those activities that being explicitly analyzed, included, taken into account, and/or processed.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “wherein”, as utilized herein, does not evidence intended use. The term “wherein” expressly refers to one or more features inclusive in a particular embodiment and does not imply or include an optional or conditional limitation.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to allow for distinguishing that particular referenced feature from another feature that is described by the same term or by a similar term. For example, a “first widget” may be so named merely to allow for distinguishing it in one or more claims from a “second widget”, so as to encompass embodiments in which (1) the “first widget” is or is the same as the “second widget” and (2) the “first widget” is different than or is not identical to the “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; (3) does not indicate that either widget ranks above or below any other, as in importance or quality; and (4) does not indicate that the two referenced widgets are not identical or the same widget. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices which are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this patent application and the title of this patent application are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein. According to some embodiments, a “processor” may primarily comprise and/or be limited to a specific class of processors referred to herein as “processing devices”. “Processing devices” are a subset of processors limited to physical devices such as CPU devices, Printed Circuit Board (PCB) devices, transistors, capacitors, logic gates, etc. “Processing devices”, for example, explicitly exclude biological, software-only, and/or biological or software-centric physical devices. While processing devices may include some degree of soft logic and/or programming, for example, such devices must include a predominant degree of physical structure in accordance with 35 U.S.C. §101.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method, comprising:
determining, by a processing device, a player gaming restriction;
determining, by the processing device and based on the player gaming restriction, a subset of available gaming sessions that satisfy the player gaming restriction; and
indicating, by the processing device and to the a device of the player, the subset of available gaming sessions that satisfy the player gaming restriction.

2. The method of claim 1, further comprising:
receiving, by the processing device and from the device of the player, player login credentials; and
verifying, by the processing device, that the player login credentials match an existing player account.

3. The method of claim 2, wherein the determining of the player gaming restriction comprises:
accessing a stored data record associated with the player account.

4. The method of claim 1, further comprising:
receiving, by the processing device and from the device of the player, an indication of the player gaming restriction.

5. The method of claim 4, wherein the indication of the player gaming restriction comprises a definition of the player gaming restriction.

6. The method of claim 1, wherein the determining of the player gaming restriction comprises:
providing, by the processing device and to a device of a gaming control entity, an indication of an identifier of the player; and
receiving, by the processing device and from the device of the gaming control entity, and in response to the providing of the indication of the identifier of the player to the device of the gaming control entity, an indication of the player gaming restriction.

7. The method of claim 6, wherein the indication of the player gaming restriction comprises a definition of the player gaming restriction.

8. The method of claim 1, wherein the determining of the player gaming restriction comprises:
querying, by the processing device and utilizing an identifier of the player, a device of a gaming control entity; and
receiving, by the processing device and from the device of the gaming control entity, and in response to the querying, an indication of the player gaming restriction.

9. The method of claim 8, wherein the indication of the player gaming restriction comprises a definition of the player gaming restriction.

10. The method of claim 1, wherein the determining of the subset of available gaming sessions that satisfy the player gaming restriction, comprises:
determining a plurality of available gaming sessions that are currently available;
determining, for each available gaming session of the plurality of available gaming sessions, a value of a gaming metric associated with the player gaming restriction;
comparing, for each available gaming session of the plurality of available gaming sessions, the value of the gaming metric to at least one criteria defined by the player gaming restriction; and
identifying, based on the comparing, the subset of the plurality of available gaming sessions that comprise gaming metric values that satisfy the criteria defined by the player gaming restriction.

11. The method of claim 1, wherein the determining of the subset of available gaming sessions that satisfy the player gaming restriction, comprises:
querying a database storing indications of a plurality of available gaming sessions that are currently available, wherein the query includes a filter based on a criteria defined by the player gaming restriction.

12. The method of claim 1, wherein the indicating of the subset of available gaming sessions that satisfy the player gaming restriction, comprises:
populating a game session interface with a listing of the subset of available gaming sessions that satisfy the player gaming restriction; and
providing the game session interface to the device of the player.

13. The method of claim 1, wherein the indicating of the subset of available gaming sessions that satisfy the player gaming restriction, comprises:
providing a game session interface with a listing of all available gaming sessions to the device of the player; and
removing, from the game session interface, listings indicative of any available game session that does not satisfy the player gaming restriction.

14. The method of claim 1, wherein the indicating of the subset of available gaming sessions that satisfy the player gaming restriction, comprises:
providing a game session interface with a listing of all available gaming sessions to the device of the player; and
altering a display of the game session interface by causing any listings indicative of any available game session that does not satisfy the player gaming restriction to appear differently than listings indicative of available gaming sessions that do satisfy the player gaming restriction.

15. The method of claim 14, wherein the altering comprises causing the listings indicative of the available game sessions that do not satisfy the player gaming restriction to appear in a grey-colored text.

16. The method of claim 1, wherein the indicating of the subset of available gaming sessions that satisfy the player gaming restriction, comprises:
providing a game session interface with a listing of all available gaming sessions to the device of the player; and
altering a display of the game session interface by causing a listings indicative of an available game session that does not satisfy the player gaming restriction to indicate that such gaming session is full.

17. The method of claim 16, wherein the available game session that does not satisfy the player gaming restriction is not full.

18. The method of claim 1, further comprising:
receiving, by the processing device, an indication of a player selection of one of the gaming sessions from the subset of available gaming sessions that satisfy the player gaming restriction;
entering, by the processing device, the player into the player-selected gaming session; and
facilitating, by the processing device, game play, by the player, in the player-selected gaming session.

19. The method of claim 1, wherein the player gaming restriction comprises one or more of (i) a maximum wager size, (ii) a maximum limit size, and (iii) a maximum buy-in size, calculated based on a loss limit associated with the player.

20. The method of claim 19, further comprising:
determining, by the processing device, a gaming incentive threshold, wherein the gaming incentive threshold comprises one or more of (i) an incentive wager size that is less than a predetermined portion of the maximum wager size, (ii) an incentive limit size that is less than a predetermined portion of the maximum limit size, and (iii) an incentive buy-in size that is less than a predetermined portion of the maximum buy-in size; and
providing, by the processing device and to the player, an incentive to select a gaming session from the subset of available gaming sessions that satisfies the gaming incentive threshold.
